(19) United States
(12) Patent Application Publication
(10) Pub. No.: US 2007/0237985 A1
(43) Pub. Date: Oct. 11, 2007

(54) Titanium Based Alloy PVD Coatings On Cast Iron Worktables For Woodworking Machines

(76) Inventors: Qing Hai XU, Nanjing (CN); Yi Hua, Nanjing (CN)

Correspondence Address: LAW OFFICES OF J.F. LEE, 17800 CASTLETON STREET, SUITE 383, CITY OF INDUSTRY, CA, 91748, US

(21) Appl. No.: 11/279,191

(22) Filed: Apr. 10, 2006

(51) Int. Cl. B32B 9/00; B32B 15/04

(52) U.S. Cl. 428/698; 428/457

(57) ABSTRACT

Surface coating for cast iron worktables of woodworking machines consists of Physical Vapor Deposition (PVD) process, using the six Titanium Alloy stocks described herein as the coating stock, to increase the rust-prevention and scratch-resistance of the worktable, and thus prolonging the useful life of the woodworking machines.

### FIELD AND BACKGROUND OF THE INVENTION

The present invention relates generally to improving the rust-prevention, hardness and the scratch-resistance attribute of case iron worktable surface that exists on the commonly available woodworking machines.

Woodworking machines such as table saws, shapers, planers, bandsaws, mitre saws, etc., are widely used in furniture industry, construction, music and other related industries. Most of these machines have one or two worktables upon which the work piece is placed during operation.

Mostly, cast iron is the material used for such worktables, due to its desired level of rigidness, ease of shaping and low cost. Moreover, cast iron worktable effectively absorbs vibrations and noise created by the motors during operations and are thus the primary material for industrial/professional grade worktables of woodworking machines.

However, like everything else, cast iron tables have some disadvantages. A cast iron worktable will rust within several hours if no rust preventives (such as oil, grease or wax) are applied over or placed on it. The situation will be worse if the machines are used in humid areas. In order to prevent rust, owners or operators of woodworking machines have to clean up worktables and place rust preventives on the tables right after the operation is completed. This obviously creates many problems, since people are not expected to be this diligent. Even with these maintenance jobs, worktables are constantly subjected to accidental banging, denting, scratching and abrasions (from hand tools, for example) and may further lose the accuracy over a period of time.

To prevent the problems stated herein, some common solutions are used, including waxing and Teflon-coating. These are not good solutions, people realized. Waxing process needs a lot of labor and usually lasts no more than two weeks. Telflon coating is relatively expensive and is not hard enough (easy to break). Furthermore, FDA is likely to issue complete ban on the use of Teflon as a coating material in the near future.

Another cast iron worktable's disadvantage lies in its intrinsic hardness (or the lack thereof). Better hardness in worktables for woodworking machines is a desired attribute, which in accordance with the Metals Handbook definition, refers to “Resistance of metal to plastic deformation, usually by indentation.” However, the term may also refer to stiffness or temper, or to resistance to scratching, abrasion, or cutting, when a load is applied. The greater the hardness of the metal, the greater resistance it has to deformation. The greater the hardness of the surface material, naturally the longer useful life of the equipment will be and resulting in higher work piece precision.

Most cast iron worktables have their surface hardness ranges from HB 170-190, using Brinell harness measurement. At this hardness level, the surface of a cast iron worktable is not quite resistant to scratches, dings or other indentations or gouging that could be inflicted upon. Consequently, the resulting precision of work piece quality may be adversely affected.

A cost-effective way to treat the surface of cast iron worktable so as to increase the hardness and rust-prevention is not available in the industry.

Present invention applies the PVD (Physical Vapor Deposition) coating process, which transfers, atom by atom, Titanium based alloy coating stocks specified herein from the solid phase to the vapor phase and back to the solid phase, gradually building a film on the surface of cast iron worktable. As Titanium alloys are known to be extremely hard and corrosion resistant materials, the woodworking machines' worktable will become rust-proof, resistant to scratch, abrasion, friction and deformation.

The stated attributes of the woodworking machines will make the maintenance cost of such machines lower, and thus more commercially desirable.

### OBJECTS AND SUMMARY OF THE INVENTION

Present invention teaches the application Titanium alloy stocks using the process of Physical Vapor Deposition (PVD) technique to coat the surface of woodworking tables, to increase the rust-prevention, hardness and scratch-resistance of the cast iron worktable surface of common woodworking machines.

Present invention effectively reduces the maintenance costs of rust-prevention, and increase the scratch resistance of the worktable surface, and the resulting work precision for the work pieces derived from machines having coating made pursuant to present invention, prolonging the useful life of woodworking machines.

After applying the coating materials disclosed and claimed herein, the surface is bonded with a strong, scratch-resistant and rust-proof film that also helps to provide good lubricity.

To measure the hardness of a PVD coated worktable surface, Brinell harness test is not quite applicable because the coating film is too thin. Therefore, Vickers Microharndess (HV) measurement needs to be applied. After PVD coating of the six (6) material stocks herein, the surface hardness of the cast iron worktable ranges in between HV 2500-3800. As a comparison, the HV hardness of cemented carbide is only HV1000-2000, so it is obviously that cast iron worktable surfaces hardness is greatly increased after PVD coating process.

The intrinsic color for each Titanium alloy contemplated in present invention will also serve the function of adding color-coding on the surface of the worktable, if such color-coding is needed in certain setting, such as danger level, group usage or work flow distinction.

### DETAILED DESCRIPTION OF THE PREFERRED EMBODIMENT

There are six (6) types of Titanium based alloys contemplated in present invention, for coating material to be coated to the surface of the woodworking machines' cast iron worktable. They are Titanium Nitride, TiN which appears in gold color; Titanium Aluminum Nitride, TiAlN which appears in purple black color; Titanium Carbonitride, TiCN which appears in Bluish Gray color; Dual Titanium Nitride, Ti2N which appears in silver color; Aluminum Titanium Nitride, AlTiN which appears in black color; Titanium Aluminum Carbonitride, TiAlCN which appears in red color.

PVD, Physical Vaporization Deposition, is fundamentally a vaporization coating process in which the basic mechanism is an atom by atom transfer of material from the solid phase to the vapor phase and back to the solid phase, gradually building a thin film on the surface to be coated.

PVD process is not invented by present application, which claims no right in the PVD process per se. However, there is no prior known art that uses PVD technique to coat the Titanium based alloys to cast iron surface of a woodworking machine.

Depending on the color(s) desired as well as other inherent attributes of the selected Titanium alloy, PVD process as used in present invention will first generate the vapor phase from the six (6) types of coating material stock, then transfer the vaporized coating to the substrate (the cast iron surface) and finally forming a thickness of between 1-5 micro mini meters (μm, or “micron”) thin but strong film of hard alloy material on the surface of cast iron worktable. This metallurgical film is chemically bonded to the cast iron substrate and will not flake, blister, chip or peel.

Although surface coating on woodworking machines is not a new thing, using PVD to coat the cast iron surface of woodworking machines becomes a desirable alternative to electroplating and possibly some painting applications. PVD can be applied using a wide variety of materials to coat an equally diverse number of substrates using any of the three basic PVD technologies to deposit a number of desired finishes of variable thickness with specific characteristics.

The application of PVD surface coating technologies at large scale, high volume operations will result in the reduction of hazardous waste generated when compared to electroplating and other metal finishing processes that use large quantities of toxic and hazardous materials.

In addition to the six Titanium based alloy stated herein, present invention can also use Chrome Nitride (CrN9) as the surface coating material, achieving substantially the same purpose of rust-prevention, scratch-resistance and increase hardness of about HV 1800. CrN9 appears in the color of silver.

What is claimed is:

1. Surface coating on worktables of woodworking machines, comprising:
a. At least one worktable made up of cast iron; and,
b. Titanium based alloy material being coated to said surface of worktable by the process of Physical Vaporization Deposition.

2. The surface coating of claim 1 wherein the Titanium based alloy is Titanium Nitride (TiN).

3. The surface coating of claim 1 wherein the Titanium based alloy is Titanium Carbonitride (TiCN).

4. The surface coating of claim 1 wherein the Titanium based alloy is Titanium Aluminum Nitride (TiAlN).

5. The surface coating of claim 1 wherein the Titanium based alloy is Dual Titanium Nitride (Ti2N).

6. The surface coating of claim 1 wherein the Titanium based alloy is Aluminum Titanium Nitride (AlTiN).

7. The surface coating of claim 1 wherein the Titanium based alloy is Titanium Aluminum Titanium Carbonitride (TiAlCN).

8. Surface coating on worktables of woodworking machines, comprising:
a. At least one worktable made up of cast iron; and,
b. Chrome Nitride as coating material to said surface of worktable by the process of Physical Vaporization Deposition.
